(19) United States
(12) Patent Application Publication
(10) Pub. No.: US 2023/0130932 A1
(43) Pub. Date: Apr. 27, 2023

(54) SYSTEM AND METHOD FOR DIGITALLY MODELING A CONSTRUCTION PROJECT

(71) Applicant: James Sperduti, Erie, CO (US)

(72) Inventor: James Sperduti, Erie, CO (US)

(21) Appl. No.: 18/082,242

(22) Filed: Dec. 15, 2022

Related U.S. Application Data
(60) Provisional application No. 63/256,268, filed on Oct. 15, 2021.

(51) Int. Cl. G06F 30/13; G06F 30/12; G06Q 50/08; G06Q 10/0631

(52) U.S. Cl. CPC G06F 30/13; G06F 30/12; G06Q 50/08; G06Q 10/06313; G06F 2111/18

(57) ABSTRACT

A system for designing and planning a construction project is disclosed, including at least one user computing device in operable connection with a user network. An application server is in operable communication with the user network to host an application system for providing a platform for designing a construction project. The application system includes a design module for providing access to the application system through the user computing device and to allow for the user to select one or more options and to view a design interface. An estimation module permits the input of the one or more options and to calculate a price of the project.

### CROSS-REFERENCE TO RELATED APPLICATIONS

The present application claims priority to U.S. Provisional Patent Application No. 63/256,268 filed Oct. 15, 2021, entitled “SYSTEM AND METHOD FOR DIGITALLY MODELING A CONSTRUCTION PROJECT” which is hereby incorporated by reference in its entirety.

### TECHNICAL FIELD

The embodiments generally relate to systems and methods for digitally modelling a construction project.

### BACKGROUND

Construction begins with planning, financing, and designing processes associated with a project or set of projects. During the planning stage, data may be gathered through site analysis, surveys, and geotechnical investigations. In the industrialized world, construction also often involves the translation of design into reality. Depending on the type of project, various design implements can be used. The increasing complexity of construction projects creates the need for design professionals to have extensive knowledge of all aspects of the project's life cycle.

Historically, designs were generated using sketches, engineering/architectural drawings, and specifications of the various components of the project. Advances in computer technologies have allowed for the widespread adoption of computer-aided design (CAD) technologies which have greatly increased productivity and accuracy of the design. In the example of a swimming pool, various design aspects must be taken into account such as the type of pool, size of the pool, intended use (i.e., public, private, competition, etc.), materials, and the like. Each design aspect has an effect on the overall price of the project.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to a system for designing and planning a construction project is disclosed, including at least one user computing device in operable connection with a user network. An application server is in operable communication with the user network to host an application system for providing a platform for designing a construction project. The application system includes a design module for providing access to the application system through the user computing device and to allow for the user to select one or more options and to view a design interface. An estimation module permits the input of the one or more options and to calculate a price of the project.

The display module of a computing device is operable to display a design interface which may include imagery of the proposed project area (e.g., a backyard wherein the client wants to install a pool). The user selects line item elements which correspond to superimposed imagery on the proposed project area. The user may also select one or more demolition areas as line item elements.

Costs for each line item element are added to the estimate, via the estimation module, in real-time. The Lidar system of the smart device (i.e., the computing device) may be used to determine a project area, demolition area, and size of the superimposed imagery of the line item elements.

The system provides a seamless experience for building and conceptually understanding a project being planned between a contractor and client and greatly reduces the turn-around time for the rough design. Having a platform which makes the design process more efficient may greatly reduce the time to generate a quote for a project and reduce the time to close the sale of the project.

In one aspect, the system provides a display having an augmented reality interface. In such, the design can be visualized in the real-world space wherein the project will be executed.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program, according to some embodiments;

FIG. 4 illustrates a screenshot of the design interface utilized for designing a swimming pool, according to some embodiments;

FIG. 5 illustrates a screenshot of the design interface showing the proposed project area, according to some embodiments;

FIG. 6 illustrates a screenshot of the design interface showing the proposed project area and demolition areas, according to some embodiments;

FIG. 7 illustrates a screenshot of the design interface showing the proposed project area showing a blank canvas in place of the demolition area, according to some embodiments;

FIG. 8 illustrates a screenshot of the design interface showing the proposed project area showing a second demolition area, according to some embodiments;

FIG. 9 illustrates a screenshot of the design interface showing the proposed project area showing a blank canvas in place of the second demolition area, according to some embodiments;

FIG. 10 illustrates a screenshot of the design interface showing the proposed project area showing a third demolition area, according to some embodiments;

FIG. 11 illustrates a screenshot of the design interface showing the proposed project area showing a blank canvas in place of the third demolition area, according to some embodiments;

FIG. 12 illustrates a screenshot of the design interface showing the proposed project area showing one or more added line item elements superimposed onto the proposed project area, according to some embodiments;

FIG. 13 illustrates a screenshot of the design interface showing the proposed project area showing one or more added line item elements superimposed onto the proposed project area, according to some embodiments; and

FIG. 14 illustrates a screenshot of the design interface showing the proposed project area showing one or more added line item elements superimposed onto the proposed project area, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to a system for modelling a design for a construction project. For clarity, the example of the life cycle of the process of designing and constructing a swimming pool is described. The system provides a seamless experience for building and conceptually understanding a project between a contractor and client and greatly reduces the turn-around time for the rough design. Having a platform which makes the design process more efficient may greatly reduce the time to generate a quote for a project and reduce the time to close the sale of the project.

The system may be utilized in the field at the construction project site to allow the user to view autogenerated cost estimates, view the price of materials, view modeling interfaces, interact with the client, and otherwise interact with the various functionalities of the system. The user may select various pre-loaded templates, materials, and other design aspects to view a model in an augmented reality interface to allow the client to visualize the completed project in their unique space. For example, the user may select various swimming pool materials, shapes, and features which are modelled in the augmented reality interface to allow the client to view the appearance of their customized swimming pool in their backyard space. In some embodiments, the system may utilize a 3-dimensional generated plane to allow the client to visualize the completed swimming pool or other construction project.

In some embodiments, the system includes a client relationship management (CRM) system which may connects to advertising automatically and brings leads in automatically to reduce the closing time of a sale. Leads may be organized following the scheduling of an estimate. For example, the system may organize the lead source, and how many times the user (e.g., a sales representative has called, texted, emailed. The system may store email, text and video templates saved in the CRM system. Prequalifying questions may be stored (e.g., timeframe, location, type of job, prior estimates estimates, etc.) to pre-qualify the client.

During the sales process, the user may schedule an estimate within the CRM, and you can see all the salespeople, which salespeople are available, and the system may automatically try to route it to the closest estimates that day or recommend moving estimates based on the route. When an estimate is scheduled, it will send the client a communication notifying them of the estimate and any details thereof.

The modeling and design system will be configured such that once an estimate is scheduled it can create a design having the client's information, address, etc. In some embodiments, the design software will be a drag and drop design software such that during an onsite meeting with the homeowner, a list of all the item which can be added is displaced (e.g., pool shapes, water feature, spa, pavers, retaining wall, sod, mulch, materials, diving boards, etc.). A modelled design of the selected pool and features thereof may be displayed on the screen and allow the user to make further selections or changes to existing selections. Following each selection and updated total cost and line item costs for each selection are calculated and displayed to the user.

In some embodiments, a quality option may be selected to allow the user to view (“good”, “better”, and “best”) options which may automatically select corresponding options and display them to the user and/or client.

In some embodiments, a 2-dimensional measuring tool may be used in tandem with satellite imagery to allow for mapping and viewing of the project in an area. Similarly, drones may be used to capture imagery of the project area.

In some embodiments, the system includes a price estimating system. The user may input production rates, services offered, material pricing, equipment they have, overhead costs and budget materials, labor, overhead, profit, etc. which is saved in the system to allow estimation spreadsheets to be automatically generated.

In some embodiments, the system includes a job onboarding system. Once the contract is signed, the scheduler would get notified and get added to a “need to schedule board”. The job is then scheduled, and the system may automatically calculate how many days the user is estimating based on man hours and the crew it's assigned to. If a project is delayed, the system may automatically move projects jobs behind it and notify the clients of the change. The system may automatically make a task for the salesperson to send the “job onboarding email” and everything would be templated and brought in automatically. The system may automatically make a task and template for our project coordinator to hit “yes” and send an onboarding group text with client, salesperson and project managers.

In some embodiments, the system automatically send them links to materials unless already specified in the estimate. Clients may access a client portal to login to see estimate, schedule, which crew, company directory, invoices, photos, etc. Once a job is started various tasks may be created for various users including calling the client, sourcing materials, setting yard signs, etc. Users may then check-off when projects are completed.

In some embodiments, the system allows for users to track their time, manage expenses, monitor labor costs, etc. The system may also allow users to track time using a digital time clock. Analytics may be provided to compare estimates to actual costs, earnings, change order information, etc.

Once a job is completed the system may automatically draft an end-of-job text or other communication which can be transmitted to the client. Review requests may also be generated to allow the client to submit a review via the system.

One skilled in the arts will readily understand that the embodiments provided herein can be implemented for various types of construction projects in the public and private sectors (e.g., building construction, landscaping, home remodels/renovations, etc.). For clarity, the example of the life cycle of designing and constructing a swimming pool is utilized.

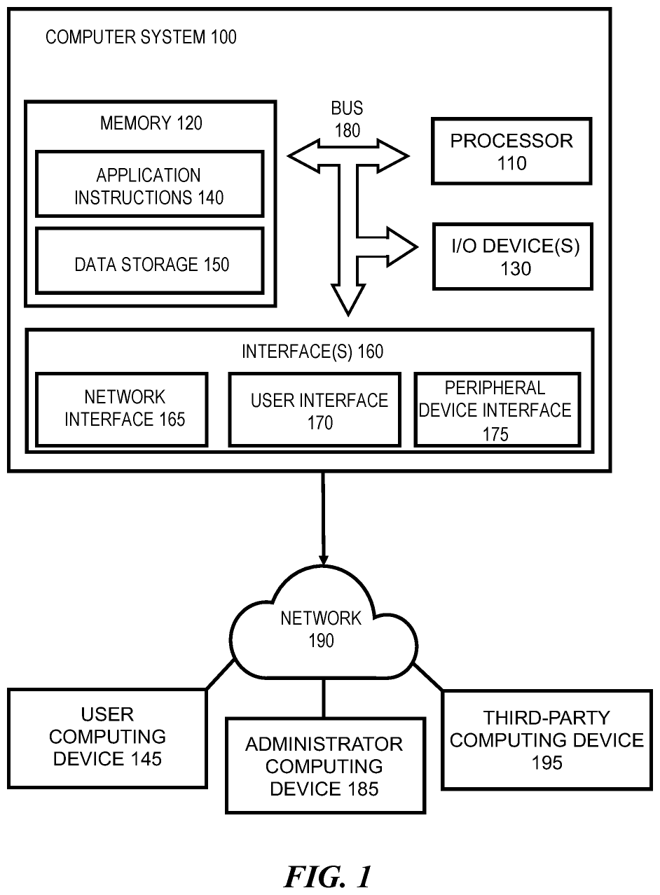

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a customer service representative, salesperson, contractor, designer, marketing specialist, estimator, etc.) to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

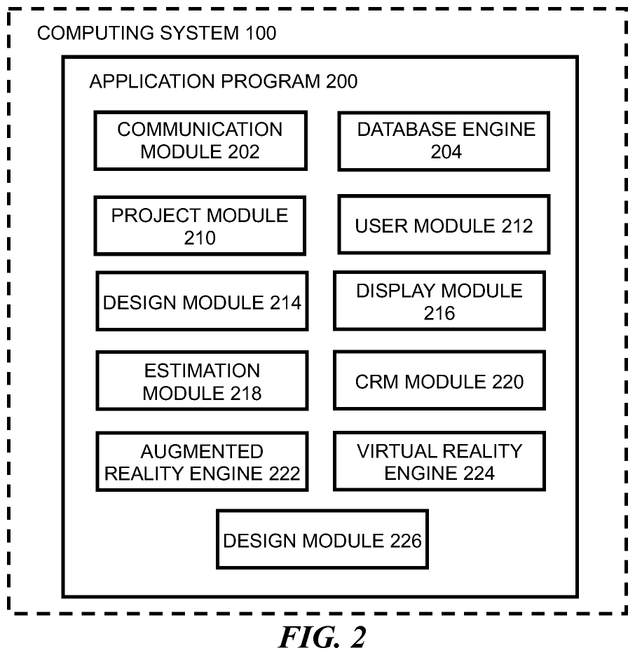

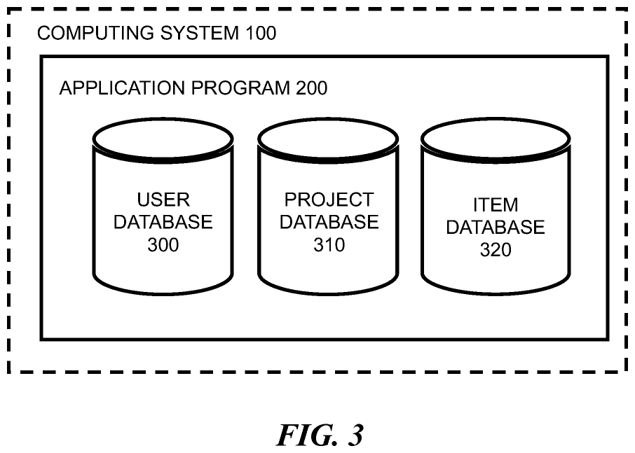

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a project module 210, a user module 212, a design module 214, and a display module 216, a time tracking module 218, a CRM module 220, an augmented reality engine, 222, a virtual reality engine 224, and design module 226.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the project module 210 is in operable communication with the computing device to allow the user to input project information as well as interact with all aspects of the life cycle of the project.

In some embodiments, the user module 212 facilitates the creation of a user account for the application system. The user module 212 may allow the user to create a user profile which includes user information, pay rates, location, project capabilities, experience, preferences, etc.

In some embodiments, the design module 214 is configured to receive user inputs related to a project and to display a rendering or virtual model of the project having the user-inputs. The design module 214 may in communication with an augmented reality engine to display the rendering in an augmented reality interface.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the estimation module 218 allows the user to input various options related to the project. Once the options are selected, a cost estimate and line items for each selection may be displayed to the user.

In some embodiments, a CRM module 220 operates a CRM platform which provides various client relationship management functionalities known in the arts. The module 220 offers a complete end-to-end platform which can facilitate the user throughout the sales cycle.

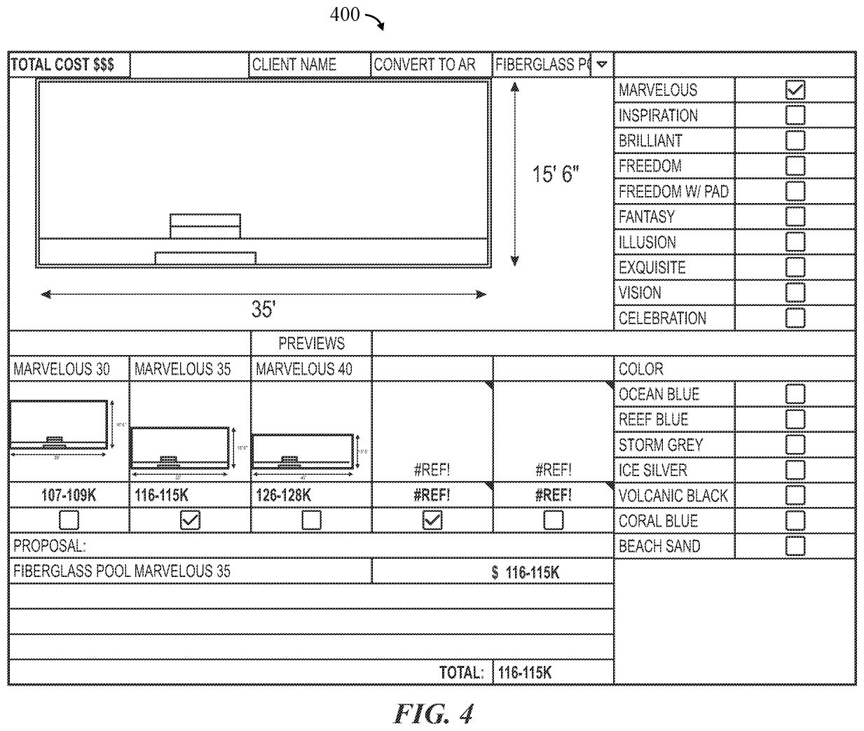

In some embodiments, the design module 226 is in communication with an augmented reality engine 222 and a virtual reality engine 224. The augmented reality engine 222 is in communication with the design module 226 to allow the user to at least partially virtually (via augmented reality themes) interact with the design interface 400 (see FIG. 4) such that the user may view an environment and/or view a construction project and its various components within the environment. Similarly, the virtual reality engine 224 may allow the user to at least partially virtually interact with the design interface 400 (see FIG. 4) such that the user may view an environment and/or view a construction project and its various components within the environment. The design module 226 may function as a useful tool for various aspects of the business including as a sales tool, customer interactions tool, marketing tool, product development tool, computer-aided design (CAD) tool, bidding tool, scheduling tool, and as a project visualization tool.

FIG. 3 illustrates the computing system 100 in operable communication with the application program 200 having a plurality of databases in communication thereto. A user database 300 is operable to store user information such as user preferences, user profile information, historical usage data, historical content, communications information, pay rate, location, scheduling preferences, project preferences, etc. The project database 310 stores project information including project estimates, project imagery, project site imagery, client information, etc. The item database 320 stores estimate information utilized to generate an estimate including item pricing, labor costs, etc.

FIG. 4 illustrates a screenshot of the design interface 400 which allows the user to select various options for a project, view project details, view the rendered design in an augmented reality interface, view pricing information, and other relevant information.

In some embodiments, the design application program is in communication with a metaverse-type environment (hereinafter referred to as the “virtual environment”) to permit the user to interact with a 3D virtual world to permit the user to socially interact with other users, interact with construction projects, etc. The virtual environment engine may permit these functionalities as well as those discussed further herein.

In some embodiments, the virtual reality engine allows the conversion of the contractor's public portfolio into a virtual world accessible using virtual reality headsets, or other smart device displays. While the user(s) (e.g., the contractor or client) will use a virtual headset, the user(s) may also simply use a smartphone or tablet display to interact with the virtual environment and its functionalities.

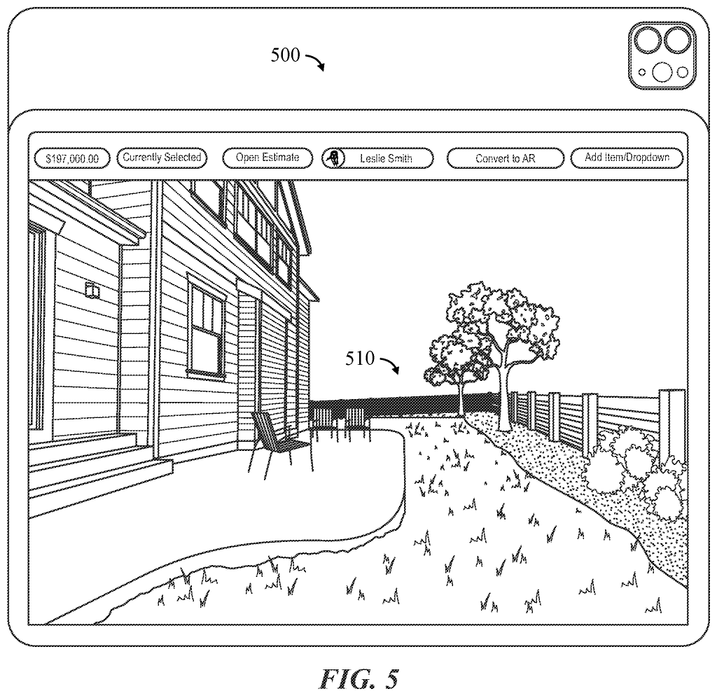

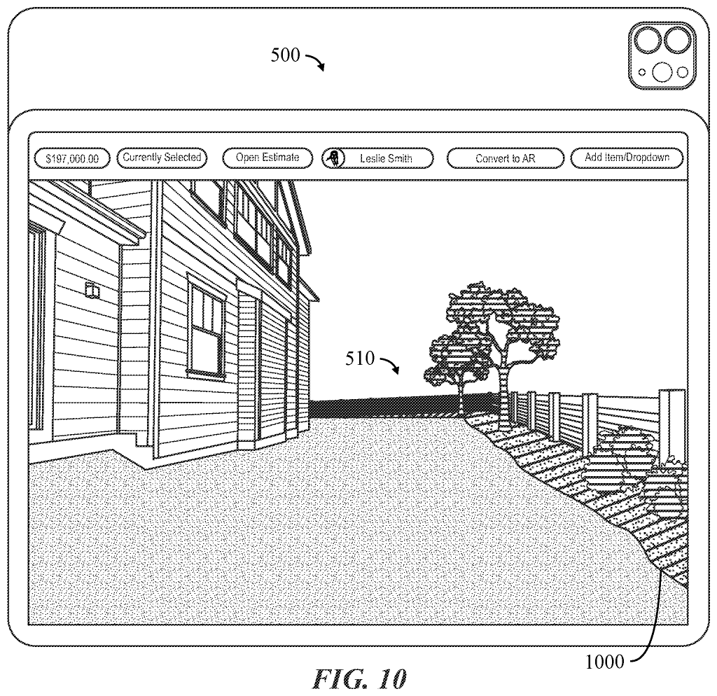

FIGS. 5-14 illustrate a design interface 500 showing a project area 510. The user will use the design interface to virtually demolish areas of the proposed project area, as well as superimpose line items onto the proposed project area to generate a virtual representation of the completed or semi-completed project. In the examples illustrated in FIGS. 5-14, the drawing figures show a step-by-step process for virtually representing backyard demolition and construction project which can be illustrated to the client before the project is started. One skilled in the arts will readily understand that processes described in FIGS. 5-14 may be accomplished in a different order, with additional steps, or without one or more steps (e.g., without demolishing the landscape (as currently illustrated in FIG. 10) or with the selection of other various line items.

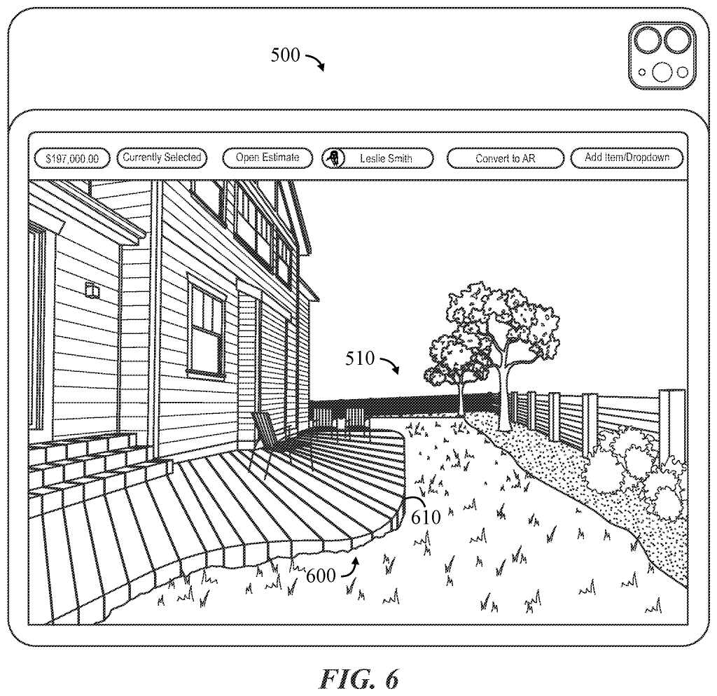

FIG. 5 illustrates a screenshot of the design interface 500 the proposed project area 510. A top portion of the design interface 500 allows the user to select various functional controls and view relevant information which is updated in real-time. For example, a price of the project with the current selected line items is updated in real time. The user may view currently selected line items, open an estimate interface, select a client (or other user), convert to AR and/or VR, and add/remove/edit line items. The proposed project area 510 in FIG. 5 illustrates a backyard of a house as it currently exists in real-life at the time the image was taken. This provides the initial construction project area which will be modified as shown in FIGS. 6-14.

In some embodiments, the image illustrated in FIG. 5 is captured using Lidar hardware of a smart device. Alternatively, the image may be captured using the camera of a smart device or other camera in communication with the network.

FIG. 6 illustrates a screenshot of the design interface 500 showing the proposed project area 510 and demolition area 600. The user has selected to demolish the concrete 610. The demolition area 600 may be indicated by a color change, dashed lines, or other visual indication. Utilizing the Lidar system of the smart device, an algorithm determines the appropriate demolition area 600 and calculates the square footage of the demolition area 600. The estimation module may then determine a cost of the demolition using the estimation system described herein. In some embodiments, the user may be prompted with questions such as “how deep is the concrete?” or similar questions to help the estimation module determine an appropriate price of the demolition. The user may select additional line items to calculate other factors associated with the demolition of the concrete (e.g., disposal, trucking fees, etc.).

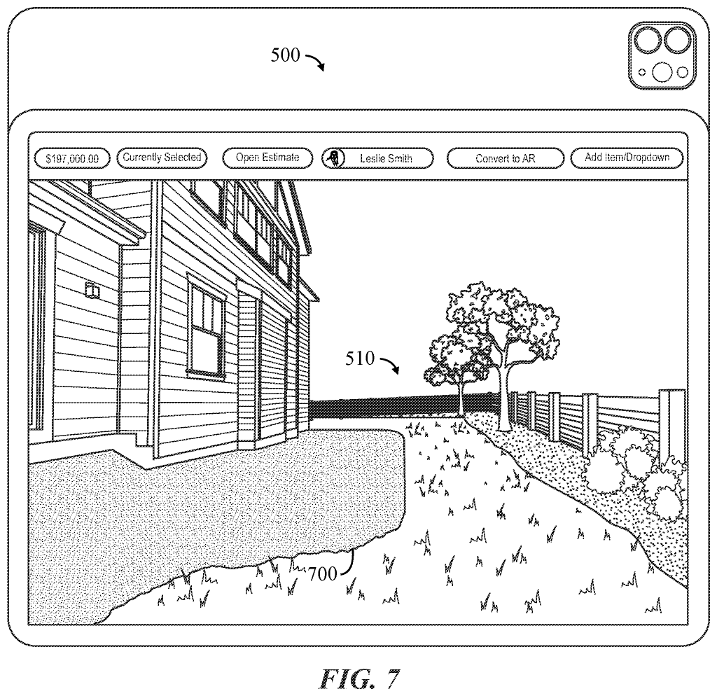

FIG. 7 illustrates a screenshot of the design interface 500 showing the proposed project 510 area showing a blank region 700 in place of the demolition area indicated in FIG. 6. The display module may input a blank region (which may be superimposed dirt). The AR/VR/MR module hides the concrete such that the user can see a more realistic view of the future construction area.

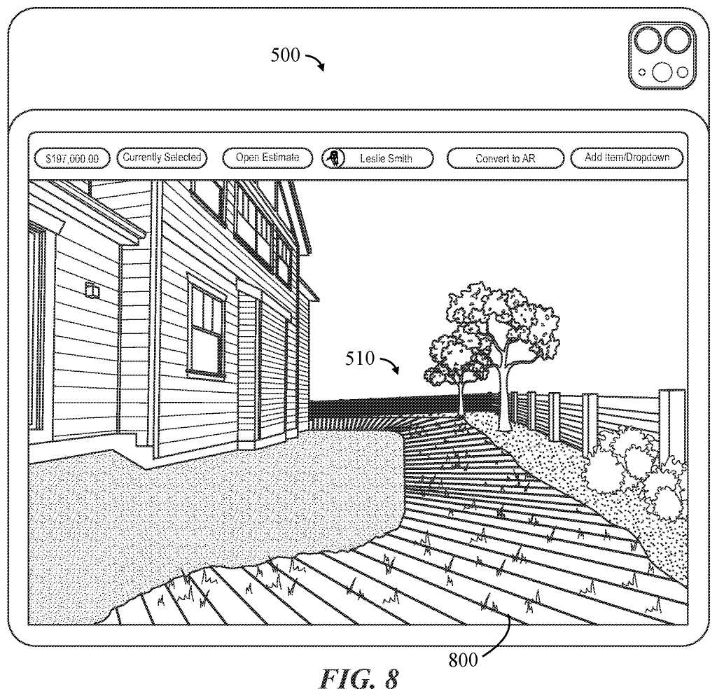

FIG. 8 illustrates a screenshot of the design interface 500 showing the proposed project area 510 showing a second demolition area 800 (illustrated as grass). The user selects a second demolition area 800 with the line item drop down menu. As described above, the estimation module may then determine a cost of the demolition using the estimation system described herein. In some embodiments, the user may be prompted with questions to help the estimation module determine an appropriate price of the demolition. The user may select additional line items to calculate other factors associated with the demolition of the grass (e.g., disposal, trucking fees, etc.).

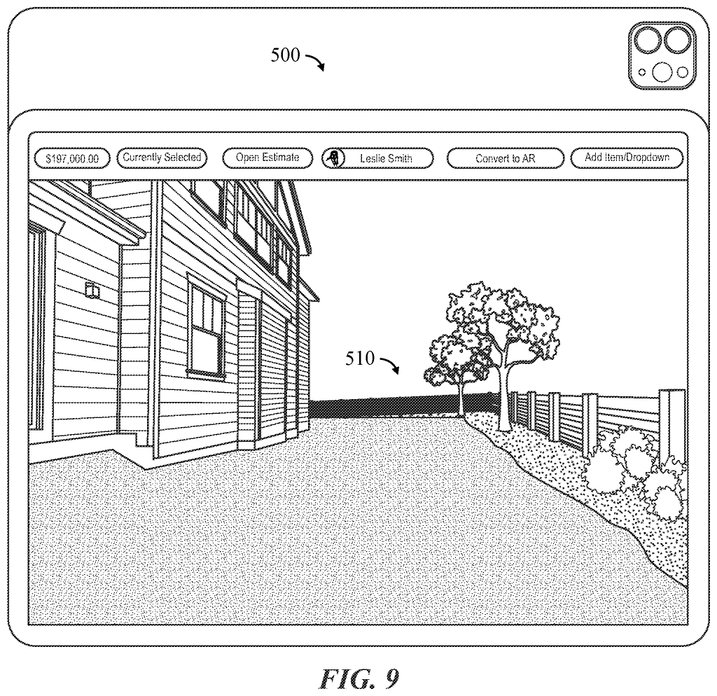

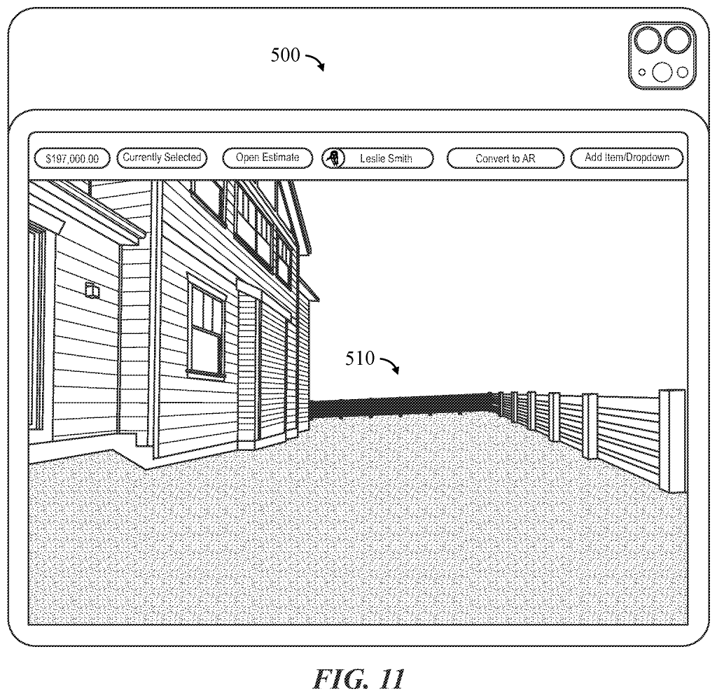

FIG. 9 illustrates a screenshot of the design interface 500 showing the proposed project area 510 showing a blank region in place of the second demolition area. As illustrated in the current example, the second demolition area has been removed. Similarly, FIG. 10 illustrates a screenshot of the design interface showing the proposed project area showing a third demolition area 1000. In the current example, the third demolition area 1000 is a landscaping area. Similar to the above examples, the estimation module may then determine a cost of the demolition using the estimation system described herein. In some embodiments, the user may be prompted with questions to help the estimation module determine an appropriate price of the demolition. The user may select additional line items to calculate other factors associated with the demolition of the landscaping and other miscellaneous items (e.g., disposal, trucking fees, etc.). FIG. 11 illustrates a screenshot of the design interface 500 showing the proposed project area 510 showing a blank canvas in place of the third demolition area.

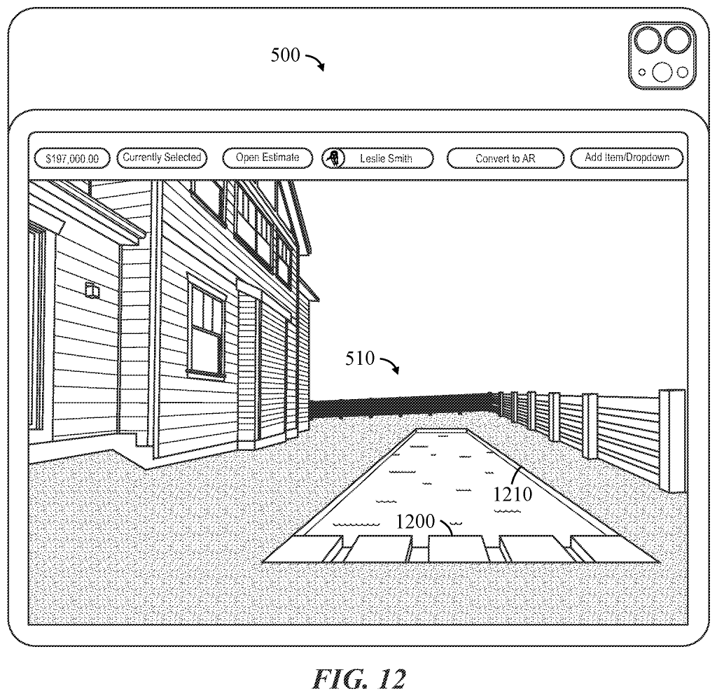

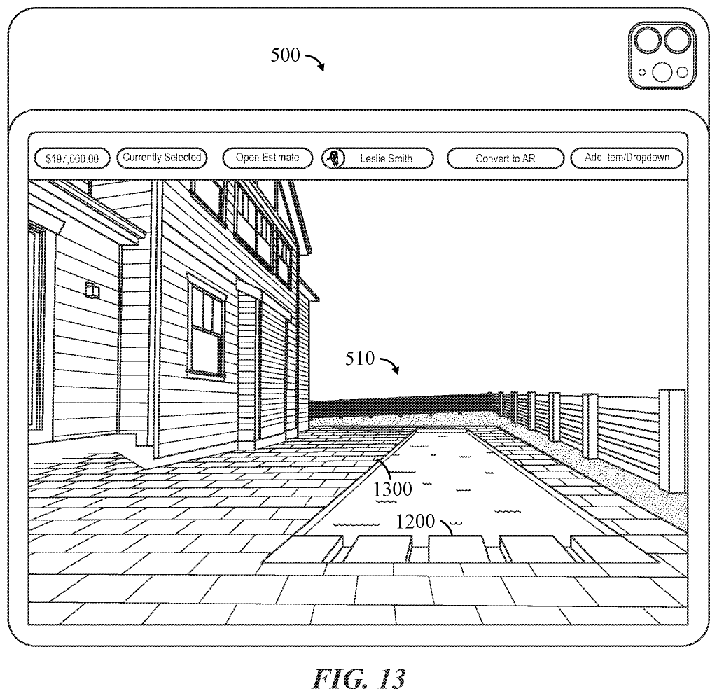

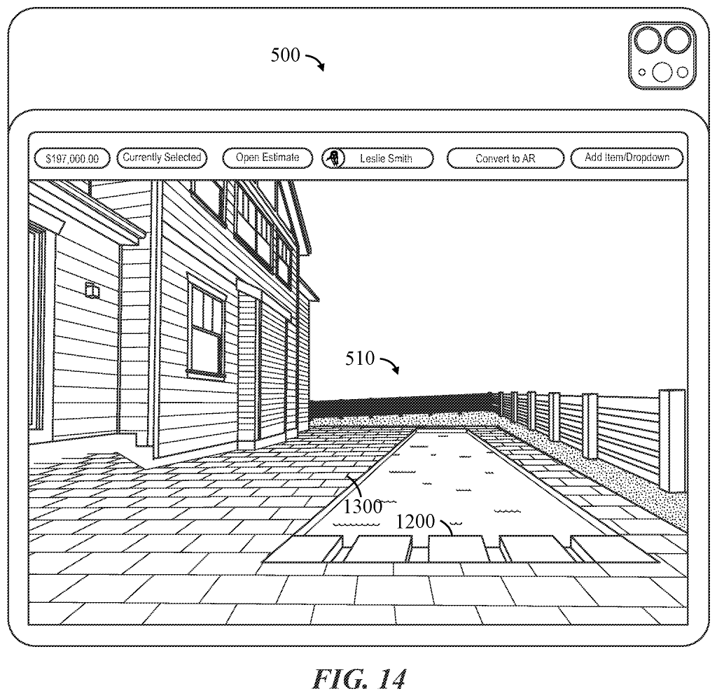

FIG. 12 illustrates a screenshot of the design interface 500 showing the proposed project area 510 showing one or more added line item elements 1200 superimposed onto the proposed project area. In the current example, the line item element 1200 is a pool 1210. While the example of a pool 1210 is used, one skilled in the arts will readily understand that the line item may be various items which are constructed, positioned, etc. in the proposed project area 510. Similarly, FIG. 13 and FIG. 14 illustrate additional line items elements 1200 such as concrete 1300, pavers, or landscaping, etc. The design module may determine an appropriate area for the line item elements 1200 to be superimposed to provide a realistic (via AR/VR) display of the line item elements in the proposed project area 510.

In some embodiments, when interacting with the virtual environment there may be a generated virtual room showcasing projects which were previously completed by the company. These may include pictures of completed projects on the wall, an interactive brochure of products used, as well as up to date insurance cards and contractors licensing. This will allow the business (or contractors) to provide potential clients and/or existing clients with a showroom consisting of various exhibits of their work, or other information.

In some embodiments, the system may include interactive animations, when the client virtually “approaches” the service desk there will be an animation of the scheduler and/or secretary. In the real world the scheduler will know there is someone at the desk and be encouraged to join the meeting. The client and scheduler can interact with each other by talking and help assist the client with any information they need. If the scheduler is unavailable with another client in the room the newly joined lead cannot overhear the conversation and will be waiting for their turn to engage and interact with the scheduler.

In some embodiments, the scheduler can transmit an alert (e.g., such as a ring) for assistance for assistance (such as from an estimator or sales representative) in helping the potential client. If the estimator is available, they will be able to join and handle the potential client (i.e., the lead).

The estimator can either immediately start assisting the lead with an estimate or ask questions of their project and lead the client into the completed projects room in the virtual environment. Here the salesperson can guide the lead into rendered worlds of completed projects and help them get inspiration. In these worlds the client will see the overall price of the project and be able to toggle before and after renders. When walking inside these renders the client will also be able to highlight different features they like as well as see a range of price for each area of the project. For example, if they see a pool, they like they can select the pool, see the specifications of the pool as well as the cost of the pool from that estimate. The software will automatically calculate for inflation or changes in overall estimating profit margins and mark up these items.

In some embodiments, the client may determine a suitable stage in the process to bring the contractor to their property virtually. In such, the contractor and/or client may utilize headsets or other devices with a display to allow the contractor to virtually view and interact with the environment wherein the project will take place. In one example, the client wears a headset having a front-facing camera which allows the camera to capture a video feed which is transmitted to the contractor's headset or other computing device having a display.

In some embodiments, the system may utilize the hardware and sensors built into the headset to allow the software to begin rendering and scaling what is present in the real world. The estimator or client can interact with building elements in this rendered world after the scan is complete. Or the client may use the augmented reality if they chose to and use both virtual and augmented reality when interacting with the building elements associated with their particular project. As line items are added, rendered materials and dimensions can be changed in real time offering real time calculations such that line item estimates are automatically updated throughout the process.

In some embodiments, the total cost may be illustrated to the client and/or other user(s) in the augmented reality and/or virtual reality display. For example, the animation for total cost will be in the sky and be changing with every added item or change in material/change in dimension. By integrating the client in this rendered world during the very rapid designing and instant estimating, the experience will allow them to approve all added items as well as the total project scope. This may result in the client being more likely to close and sign upon the first contact with the company before and reduce time required by the salesperson during the client onboarding and initial design processes.

In some embodiments, once the project is scheduled the foreman(s) and project manager(s) can access the world and use it for reference of where proposed line items are supposed to be.

In some embodiments, all underground utilities can be documented by utility locators (e.g., 811) and be able to illustrate exactly where those lines are locating in 3-dimensions. This allows the client and/or contractors to view the location of the underground utilities in augmented reality, virtual reality, as well as provide a tool for marking utilities in the real world.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for designing and planning a construction project, the system comprising:
at least one user computing device in operable connection with a user network;
an application server in operable communication with the user network, the application server configured to host an application system for providing a platform for designing a construction project, the application system having a design module for providing access to the application system through the user computing device and to allow for the user to select one or more options and to view a design interface; and
an estimation module to permit the input of the one or more options and to calculate a price of the project based on the selection of one or more line item elements stored in an item database.

2. The system of claim 1, further comprising a project database to store a plurality of project information.

3. The system of claim 2, further comprising an item database in communication with the estimation module to store one or more item prices.

4. The system of claim 1, further comprising a CRM module to permit access to a CRM system.

5. The system of claim 1, further comprising a design module to access a design interface whereon the user selects one or more demolition areas and the one or more line item elements.

6. The system of claim 5, wherein the one or more user-selected line item elements are superimposed on a proposed project area.

7. The system of claim 6, wherein a Lidar system in communication with a smart device is used to calculate a square footage of a proposed project area.

8. The system of claim 7, wherein the Lidar system is used to calculate the square footage of a demolition area.

9. A system for designing and planning a construction project, the system comprising:
at least one user computing device in operable connection with a user network;
an application server in operable communication with the user network, the application server configured to host an application system for providing a platform for designing a construction project, the application system having a design module for providing access to the application system through the user computing device and to allow for the user to select one or more options and to view a design interface, the computing device including a Lidar system to calculate a demolition area;
an augmented reality engine to display an augmented reality interface to illustrate at least one line item element;
an estimation module to permit the input of the one or more options and to calculate a price of the project.

10. The system of claim 9, further comprising a project database to store a plurality of project information.

11. The system of claim 10, further comprising an item database in communication with the estimation module to store one or more item prices.

12. The system of claim 11, further comprising a CRM module to permit access to a CRM system.

13. The system of claim 12, wherein the Lidar system is in communication with the computing device.

14. The system of claim 13, further comprising a design interface illustrating imagery of a proposed project area.

15. The system of claim 14, wherein the Lidar system calculates the area of the proposed project area.

16. The system of claim 15, wherein the Lidar system is in communication with the estimation module to provide an autogenerated cost estimate.

17. The system of claim 16, wherein the autogenerated cost estimate is updated in real-time upon selection of one or more line item elements.

18. The system of claim 17, wherein the one or more line item elements are stored in an item database.

19. The system of claim 18, wherein the estimation module generates an estimate corresponding to the one or line item elements superimposed on the proposed project area.

20. The system of claim 19, wherein a project database stores the proposed project area, user-selected line item elements, and cost estimate.
